(19) United States
(12) Patent Application Publication
(10) Pub. No.: US 2003/0169639 A1
(43) Pub. Date: Sep. 11, 2003

(54) Fodder mixer

(76) Inventor: Nicolaas Van Der Plas, Oldenzaal (NL)

Correspondence Address: FLYNN THIEL BOUTELL & TANIS, P.C., 2026 RAMBLING ROAD, KALAMAZOO, MI, 49008-1699, US

(21) Appl. No.: 10/351,980

(22) Filed: Jan. 27, 2003

(30) Foreign Application Priority Data
Jan. 29, 2002 (DE) 202 01 339.1

(51) Int. Cl. B01F 7/24

(52) U.S. Cl. 366/297; 366/306; 366/314; 366/323

(57) ABSTRACT

A fodder mixer (1, 20, 30, 40) is described, which comprise a mixing chamber (2) having a fodder discharge opening (6, 26) and a bottom (4, 24, 34). The mixing chamber is provided with at least two vertical screws (7, 37), which are adapted to be rotatingly driven and which are used for mixing the fodder and for moving it in a feed direction (F) to the fodder discharge opening (6, 26), each vertical screw being provided with a pick-up edge (9) which picks up fodder from the bottom and which sweeps over a flight circle projected onto said bottom. In order to optimize such a fodder mixer with respect to its conveying capacity, the present invention suggests that a fodder baffle surface (12, 13, 22, 23, 33) should be provided, which extends upwards from said bottom and which is effective in a direction opposite to the feed direction (F), said fodder baffle surface being associated with the flight circle of the pick-up edge (9) in a transition area (11, 21, 31) between neighbouring vertical screws.

The present invention refers to a fodder mixer of the type explained in the generic clause of claim 1.

Such a fodder mixer is known from DE-U 200 12 862. In this fodder mixer the mixing chamber has arranged therein two or even more than two mixing screws which are rotatingly driven such that they rotate about a vertical axis, preferably in the same direction. The vertical mixing screws have a pick-up edge which is arranged at the lower end of the screw channel and which picks up the fodder from the bottom of the mixing chamber in a shovel-like manner. The screw channels of the vertical mixing screws become increasingly narrower from the pick-up edge towards the top of the mixing chamber so that the room available for accommodating the fodder becomes increasingly less towards the top. The fodder is therefore picked up from the bottom by the pick-up edge and transported upwards due to the rotation of the vertical screws and, in view of the increasingly narrowing screw channel, it will gradually drop downwards so that a good mixing effect will be achieved. The vertical screws are arranged so close to one another that they sweep over the largest possible area of the bottom so that the number of dead corners in which fodder may be remain on said bottom is reduced to a large extent. In the known fodder mixer the triangular spaces, which exist between neighbouring vertical screws and the normally straight wall of the mixing chamber and which are not swept over by the flight circle of any vertical screw, are covered by expediently designed guide cones on which the fodder is pushed upwards by one of said vertical screws and thrown off from above onto the other vertical screw when it reaches or before it reaches the top of the guide cone. Another transfer possibility exists in the area in which the flight circles of neighbouring vertical screws touch one another, said flight circles being swept over by the pick-up edge. There, the transfer of fodder is, however, problematic; in extreme cases, it may happen that, at this location, the fodder is only pushed to and fro between neighbouring vertical screws, without being conveyed in the direction of the fodder discharge opening. Furthermore, a kind of envelope consisting of fodder may form in the transition area between the two vertical screws, said envelope preventing fodder from being flung away from the screw channel of one vertical screw to the other vertical screw under the influence of the centrifugal forces caused by the rotation of the screw.

It is the object of the present invention to provide a fodder mixer in which the transfer of fodder between two vertical screws is optimized.

This object is achieved by the features disclosed in claim 1.

The structural design according to the present invention guarantees that, in the transition area, the fodder cannot move in a direction opposite to the previously defined feed direction towards the fodder discharge opening, without the mixing result and the movement of the fodder in the feed direction being disturbed.

Advantageous further developments of the invention are disclosed in the subclaims.

In the following, embodiments of the present invention will be explained in detail making reference to the drawings in which:

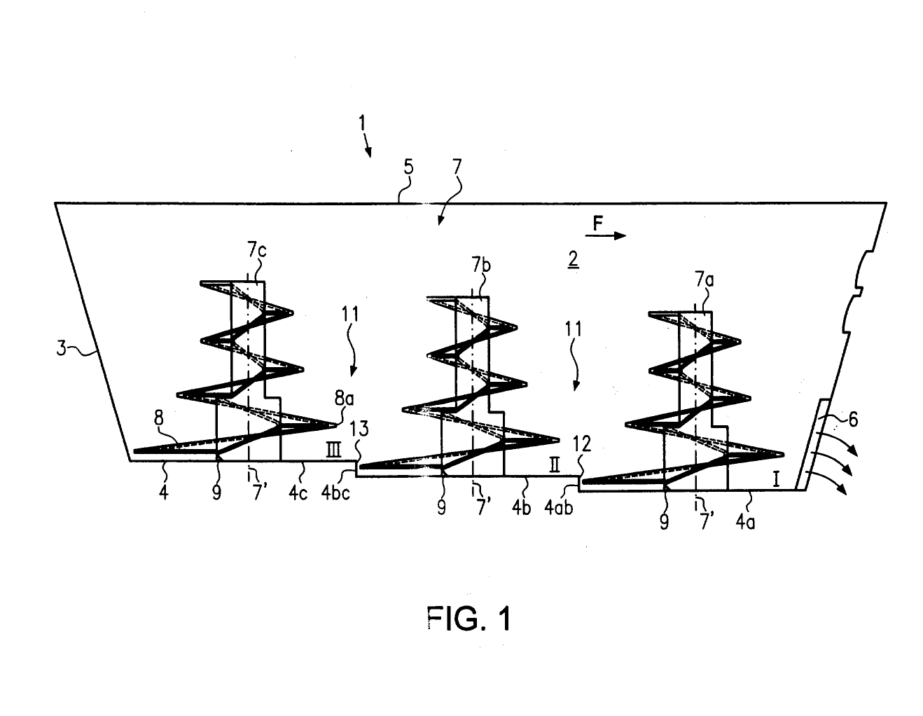

FIG. 1 shows a schematic representation of a first embodiment of a fodder mixer according to the present invention in a longitudinal section,

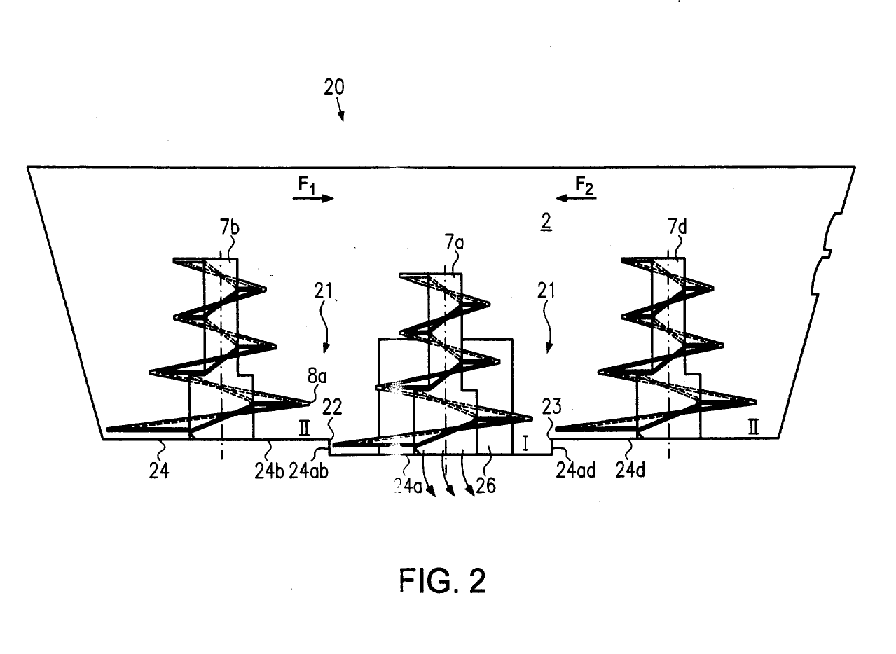

FIG. 2 shows a schematic representation of a further embodiment of a fodder mixer according to the present invention in a longitudinal section,

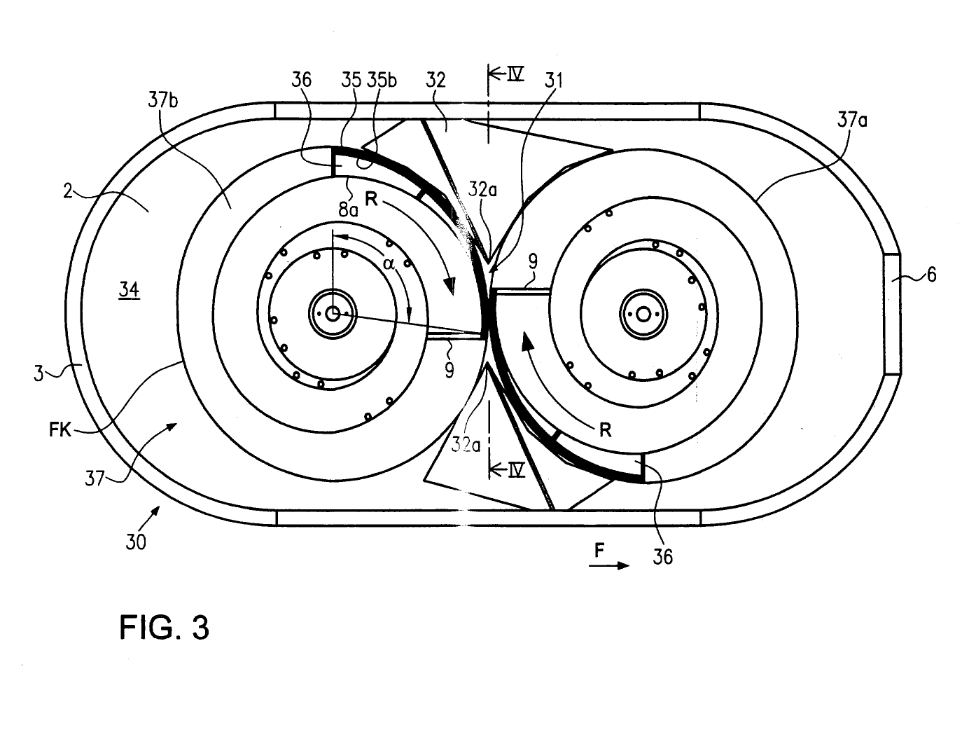

FIG. 3 shows a schematic representation of a further embodiment of a fodder mixer according to the present invention in a cross-sectional view,

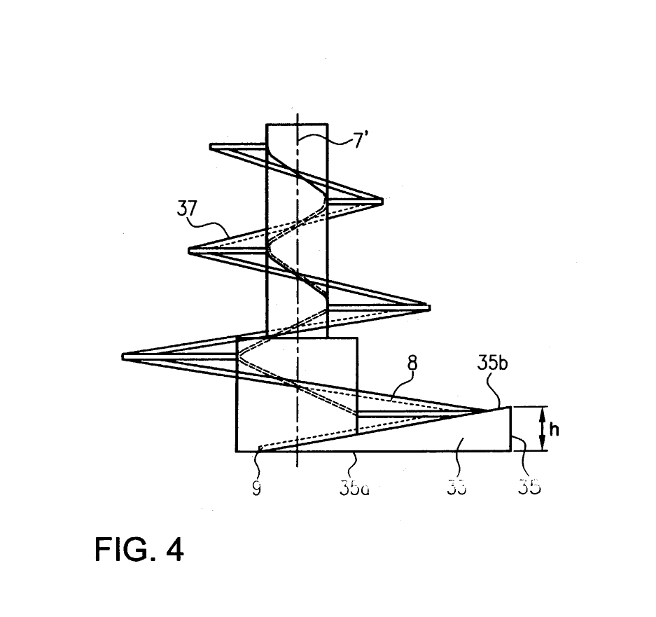

FIG. 4 shows the view IV-IV of FIG. 3, and

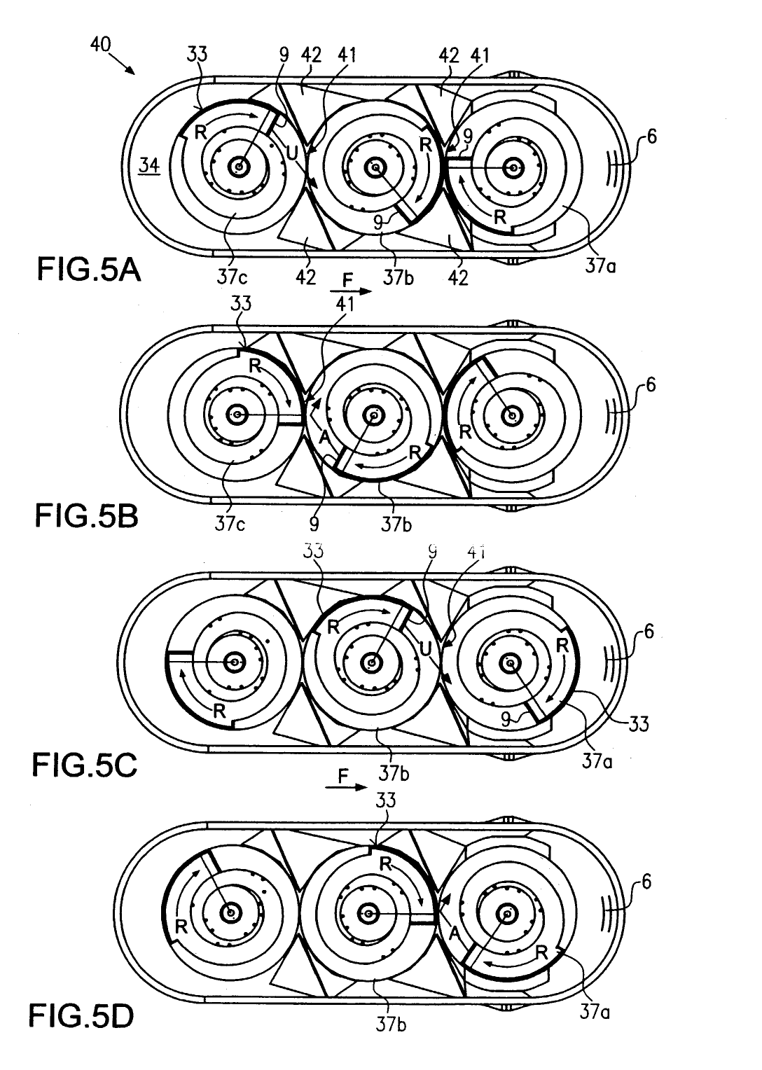

FIGS. 5A, B, C, D show, in a cross-sectional view, a schematic representation of a further embodiment of a fodder mixer according to the present invention in four different operating phases.

FIG. 1 shows a longitudinal section through a first embodiment of a fodder mixer 1 designed in accordance with the present invention. The fodder mixer 1 is preferably implemented as a conventional feeder wagon, which can be moved along a feeding alley and which, in the course of this movement, discharges fodder in the form of a swath. Such fodder mixers comprise a fodder chamber 2, which is defined by walls 3 and a bottom 4 and which has an upper opening 5 through which fodder is introduced into the interior of the mixing chamber 2. The fodder can be discharged from the mixing chamber 2 via a discharge opening 6 on the wall representing the front wall or the rear wall, when seen in the direction of movement; preferably, said discharge opening 6 is, however, provided on the front transverse wall of the fodder mixer 1 so that the driver of the tractor can see it more easily.

In the interior of the mixing chamber 2, a plurality of mixing screws 7 is arranged, each of said mixing screws 7 being adapted to be rotatingly driven about a vertical axis 7′ by known drive means which are not shown in the figure. Each of the vertical screws 7 includes a screw channel 8 which drags along the bottom 4 with a pick-up edge 9 or which moves along said bottom 4 at a small distance therefrom. The pick-up edge 9 is designed such that it is able to pick up, in a shovel-like manner, the fodder lying on the bottom 4.

The feed width of the screw channel 8 decreases from the pick-up edge 9 on the bottom 4 towards the opening 5 at the top so that each vertical screw 7 has a profile that tapers upwards with a substantially conical shape. In this way, the flight circle, which is described by the radially outermost point of the pick-up edge 9 and which is projected onto the bottom 4, is larger than the flight circles of all the other points on the radially outer circumference 8a of the screw channel 8.

The vertical screws 7 are arranged in a row one after the other; when, as in the case of the embodiment shown, three vertical mixing screws 7 are used, the vertical screw 7a is arranged directly at the discharge opening 6 and the vertical screw 7c is arranged at the point of the mixing chamber 2 that is most remote from said discharge opening 6; depending on the size of the mixing chamber 2, one or a plurality of vertical screws 7b can be arranged between said first-mentioned vertical screws.

All the vertical screws 7 are coiled in the same direction and are driven by drive means, which are not shown, in the usual way in the same direction and preferably at the same speed so as to generate a preferred feed direction F towards the discharge opening 6. The fodder is transferred from one vertical screw to the next in transition areas 11 in which the connection between two neighbouring vertical screws is open for this purpose.

In the embodiment shown, the pick-up edges 9 of all three vertical screws 7a, 7b, 7c are at the same point of their rotary path about the vertical axis 7′, but this is not a necessary pre-condition in the case of this embodiment.

The fodder mixer 1 has a stepped bottom with three height-graduated levels I, II and III; level I, which represents the lowest level when seen in the direction of the force of gravity, borders on the fodder discharge opening 6 and the highest level III is provided in the area of the mixing chamber 2 which is most remote from the discharge opening 6. Each level I, II, III has a bottom area 4a, 4b and 4c which is not much larger than the flight circle of the pick-up edge 9 of the vertical screw 7 rotating on the respective level I, II and III. The bottom areas 4a and 4b, and 4b and 4c, respectively, are interconnected by steps 4ab, 4bc carrying respective baffle surfaces 12 and 13, which are directed towards the lower levels I and II in question. Each baffle surface 12, 13 extends around the flight circle of the respective lower vertical screw 7 over at least the transition area 11, is curved in correspondence with the flight circle of the lower vertical screw 7 and is located on or slightly outside of the flight circle of the lower vertical screw 7. The vertical height of each baffle surface 12, 13 corresponds approximately to the vertical distance of a point on the circumference of the screw channel 8 which, during the rotation of the vertical screw 7, enters the transition area 11 just as the pick-up edge 9 is leaving said transition area 11. In this way, the baffle surfaces 12 and 13 prevent fodder from being fed back from a lower level I, II to a higher level II, III in a direction opposite to the preferred feed direction F, whereas in said feed direction F the fodder can, of course, be fed unhindered over all three levels towards the discharge opening 6.

FIG. 2 shows a further embodiment of a fodder mixer 20 in the case of which the principle of the fodder mixer 1 is applied to a fodder mixer having a laterally and centrally arranged discharge opening 26. Also in this case, three of the vertical screws 7, which have already been described, are provided, one vertical screw 7a being arranged directly at the discharge opening 26 and the other two vertical mixing screws 7b and 7d being arranged on either side of the first conveying screw 7a in more remote areas of the mixing chamber 2. The vertical mixing screws 7a, 7b, 7d are driven by conventional measures such that two preferred feed directions, F, from the vertical mixing screw 7b to the vertical mixing screw 7a, and F₂ from the vertical mixing screw 7d to the vertical screw 7a are defined.

The bottom 24 of the mixing chamber 2 comprises two height levels I and II, the height level I, which is located closest to the discharge opening 26, being the lowest level and the height levels II, which are remote from the discharge opening 26, being the higher levels. In this way, three bottom areas 24a, 24b and 24d are again implemented for respective ones of the vertical screws, the bottom area 24a defining with each of the bottom areas 24b, 24d a step 24ab, 24ad carrying a respective baffle surface 22, 23. The bottom areas 24a, 24b and 24d, the steps 24ab, 24ad and the baffle surfaces 22 and 23 are comparable with the structural design that has already been described with reference to the fodder mixer 1 so that these components are not explained once more.

Also the baffle surfaces 22, 23 of the embodiment according to FIG. 2 prevent fodder from being fed back in a direction opposite to the preferred feed directions F₁, F₂ from the central vertical screw 7a at the discharge opening 26 to the more remote vertical screws 7b and 7d.

Making reference to FIGS. 3 to 5, a further design principle of the present invention will be explained. FIG. 3 shows a top view of a schematically represented fodder mixer 30 in which the interior of the mixing chamber 2 can be seen. The fodder mixer 30 is, similar to the fodder mixer 1, provided with a fodder discharge opening 6 which is located at the front, when seen in the direction of movement. The mixing chamber 2 of this embodiment is provided with a flat bottom 34 having arranged thereon two vertical screws 37, which, with the exception of the details described hereinbelow, correspond to the vertical screws 7 and which are rotatingly driven. Also in this case, a first vertical screw 37a is located close to the fodder discharge opening 6 and a second vertical screw 37b is located in the rear area of the mixing chamber 2. Both vertical screws 37a, 37b are arranged immediately adjacent to one another, they are coiled in the same direction and they are driven in the same direction so that they define a preferred feed direction F towards the discharge opening 6. Possible dead spots in the interior of the mixing chamber 2 are filled by guide elements 32 in a manner known and described e.g. in DE-U-200 12 862, said guide elements being designed such that they support the preferred feed direction F. The tips 32a of the guide elements 32 extend into the triangular space between neighbouring vertical screws 37a and 37b on the bottom 34 and leave a transition area 31 between said vertical screws 37 free; through this transition area 31 fodder can be transferred from one vertical screw to the neighbouring vertical screw.

In order to guarantee that this transfer essentially takes place exclusively in the preferred feed direction F, each vertical screw 37 has connected thereto a baffle surface 33 which is arranged on an apron 35 secured to the vertical screw 37. The apron 35 is approximately triangular in shape, it starts at the pick-up edge 9 and extends rearwards in a direction opposite to the direction of rotation R. The apron 35 is secured in position such that the baffle surface 33 extends essentially at right angles to the bottom 34. The lower edge 35a of the apron 35 extends parallel and close to the bottom 34, whereas the upper edge 35b ascends with the same inclination as the screw channel 8.

The apron 35 is curved with a radius corresponding to the radius of the flight circle FK of the pick-up edge 9 and extends over an angular area a corresponding at least to the width of the transition area 31 between the tips 32a on the bottom 34. In the embodiment shown, the angular area a is larger than the distance between the tips 32a on the bottom 34 and amounts to approx. 100°.

Due to the width of the screw channel 8, which becomes narrower towards the top, a radial gap 36, which increases in width, opens between the outer circumferential edge 8a of the screw channel 8 and the upper apron edge 35b that follows the curvature of the flight circle FK; the fodder thrown off from above due to the centrifugal forces and the narrowing width of the screw channel 8 can fall through this radial gap 36 onto the bottom 34 in the usual way, so that it can be picked up again by the pick-up edge 9 and transported to the top via the screw channel. Especially in the case of screws having a comparatively small diameter, it is, however, also possible to cover the gap between the outer edge 8a of the screw channel 8 and the upper edge 35b of the apron 35 in a suitable manner by a plate or the like (cf. also FIG. 5).

In this fodder mixer 30 it is possible to determine and to control the transfer direction from one vertical screw 37 to the neighbouring vertical screw 37 by a suitable synchronization of the rotation of the two vertical screws. The criterion for this synchronization is the position of the pick-up edges 9 of the two vertical screws 37 relative to one another. The expedient synchronization will be shown hereinbelow on the basis of a further embodiment of a fodder mixer 40 according to FIGS. 5A to 5D. The fodder mixer 40 corresponds approximately to the fodder mixer 30, but it comprises three of the vertical screws 37, which are shown in FIGS. 3 and 4 and which are provided with the apron 35 and the baffle surface 33; these three vertical screws are arranged in a row one after the other in increasingly spaced relationship with the discharge opening 6 on a flat bottom 34. The transition areas 41 between neighbouring vertical screws are determined, in analogy with the fodder mixer 30 of FIG. 3, by expediently designed guide elements. All three vertical screws 37a, 37b and 37c are coiled in the same direction, they have the same direction of rotation R and they preferably rotate at the same rotational speed.

The angular position of the pick-up edges 9 of neighbouring vertical screws 37 relative to one another is, however, determined as follows.

As can be seen in FIG. 5A, the relative position of the pick-up edges 9 and of the baffle surfaces 33 of the vertical screws 37b and 37c connected thereto is determined such that, when the pick-up edge 9 of the rearmost vertical screw 37c approaches the transition area 41 to the central vertical screw 37b, the pick-up edge 9 and the baffle surface 33 of the central vertical screw 37b open the transition area 41 so that the fodder, which the pick-up edge 9 of the screw 37c pushes ahead of itself, will be pushed in the direction of the arrow U onto the screw channel 8 and below the screw channel 8, respectively, in the area of the central screw 37b, i.e. said fodder will move in the preferred feed direction F.

FIG. 5B shows that, when the pick-up edge 9 of the central vertical screw 37b approaches the transition area 41 to the rear screw 37c, the baffle surface 33 of the rear screw 37c reaches and increasingly covers said transition area 41. The baffle surface 33 will therefore prevent the fodder pushed ahead by the pick-up edge 9 of the central screw 37b from being pushed back into the area of the rear screw 37c, the fodder moving thus in the baffling direction A, i.e. it will remain in the area of the central screw 37b.

As can be seen in FIGS. 5C and 5D, the rotation of the first vertical screw 37a, which is located closest to the discharge opening 6, is coordinated in the same way with the rotation of the neighbouring, central vertical screw 37b. Also in this case, the angular position of the respective pick-up edges 9 and of the baffle surfaces 33 connected thereto is chosen such that the pick-up edge 9 of the central vertical screw 37b can transfer the fodder in the direction of the arrow U to the front screw 37a while the transition area 41 between the front and central screws 37a, 37b is blocked by the baffle surface 33 of the central screw 37b during passage of the pick-up edge 9 of the front screw 37a.

The above explanations show that, in the case of the preferred feed direction F that has been chosen, it is not absolutely necessary to provide the vertical screw 37a located closest to the discharge opening 6 with the baffle surface 33 for the purpose of supporting the feed in the preferred feed direction F.

The synchronization of the vertical screws 37a to 37c is effected preferably with an angular displacement between 30 and 90°, preferably in the range of approx. 60°.

For modifying the described and depicted embodiments, the details described and shown in the figures can be interchanged. A fodder mixer according to FIGS. 1 and 2 may, for example, be equipped with only two screws. In the fodder mixers of FIGS. 1 and 2, guide elements can be provided which correspond to those of the fodder mixers according to FIGS. 3 to 5. The arrangement of the vertical screws relative to one another can be varied in accordance with the position of the fodder discharge opening. In addition, any other suitable kind of conveying screws can be used as vertical screws. The baffle surfaces can be arranged at any location of the transition area where they will support the feed of the fodder in a preferred feed direction. It would, for example, be imaginable that the respective conveying screw actuates a mechanism which blocks transfer of the fodder in one direction as soon as an appropriate relative position of the screws has been reached.

1. A fodder mixer (1, 20, 30, 40) comprising a mixing chamber (2) having a fodder discharge opening (6, 26) and a bottom (4, 24, 34), and further comprising at least two vertical screws (7, 37), which are adapted to be rotatingly driven and which are used for mixing the fodder and for moving it in a feed direction (F) to the fodder discharge opening (6, 26), each vertical screw (7, 37) being provided with a pick-up edge (9) which picks up fodder from the bottom (4, 24, 34) and which sweeps over a flight circle (FK) projected onto said bottom (4, 24, 34), characterized by a fodder baffle surface (12, 13, 22, 23, 33) extending upwards from said bottom (4, 24, 34) and effective in a direction opposite to the feed direction (F), said fodder baffle surface (12, 13, 22, 23, 33) being associated with the flight circle (FK) of the pick-up edge (9) in a transition area (11, 21, 31) between neighbouring vertical screws (7, 37).

2. A fodder mixer according to claim 1, characterized in that the baffle surface (12, 13, 22, 23, 33) is associated at least with the transition area (11, 21, 31) between the vertical screw (7a, 37a) located closest to the fodder discharge opening (6, 26) and the neighbouring vertical screw (7b, 7d, 37b).

3. A fodder mixer according to claim 1 or 2, characterized in that the baffle surface (12, 13, 22, 23, 33) has a radius of curvature which corresponds to that of said flight circle (FK).

4. A fodder mixer according to one of the claims 1 to 3, characterized in that the baffle surface (12, 13, 22, 23, 33) has a length which corresponds at least to the length of the transition area (11, 21, 31).

5. A fodder mixer according to one of the claims 1 to 4, characterized in that the baffle surface (12, 13, 22, 23, 33) extends over an angular area of the flight circle (FK) of from 30 to 180°.

6. A fodder mixer according to one of the claims 1 to 5, characterized in that each of the neighbouring vertical screws (7, 37) has associated therewith a respective baffle surface (12, 13, 22, 23).

7. A fodder mixer according to one of the claims 1 to 6, characterized in that the baffle surface (12, 13, 22, 23) is defined by a respective step in the bottom between a pick-up edge (9) rotating located on a higher level (II, III) and a pick-up edge (9) rotating on a lower level (I, II).

8. A fodder mixer according to claim 7, characterized in that the step in the bottom has a height of from 10 cm to 50 cm.

9. A fodder mixer according to claim 7 or 8, characterized in that the pick-up edge (9) located closest to the fodder discharge opening (6, 26) rotates on the lowest level (I).

10. A fodder mixer according to one of the claims 1 to 6, characterized in that the baffle surface (33) is connected to the pick-up edge (9).

11. A fodder mixer according to claim 10, characterized in that the baffle surface (33) is arranged on an apron (35) which starts at the pick-up edge (9) and which is associated with the space (h) between a part of the screw channel (8) bordering on said pick-up edge (9) and the bottom (34).

12. A fodder mixer according to claim 10 or 11, characterized in that the rotation of the first vertical screw provided with a baffle surface (33) is coordinated with the rotation of the neighbouring second vertical screw in such a way that the baffle surface (33) of the first vertical screw covers the transition area (31) when the pick-up edge (9) of the neighbouring vertical screw moves through said transition area (31).

13. A fodder mixer according to claim 12, characterized in that neighbouring vertical screws (37) rotate with a displacement of from 30 to 90°, preferably 60°, relative to one another.

14. A fodder mixer according to claims 10 to 13, characterized in that the mixing chamber (2) has arranged therein a plurality of vertical screws (37) which are rotatingly driven in the same direction and which are arranged in a row in the direction of the fodder discharge opening (6), each of said vertical screws (37) being provided with a baffle surface (33).
